(19) United States
(12) Patent Application Publication
(10) Pub. No.: US 2008/0033810 A1
(43) Pub. Date: Feb. 7, 2008

(54) System and method for forecasting the performance of advertisements using fuzzy systems

(75) Inventor: Victor K. Chu, Milpitas, CA (US)

Correspondence Address: DREIER LLP, 499 PARK AVE, NEW YORK, NY, 10022, US

(73) Assignee: Yahoo! Inc., Sunnyvale, CA (US)

(21) Appl. No.: 11/498,638

(22) Filed: Aug. 2, 2006

(51) Int. Cl. G06Q 30/00

(52) U.S. Cl. 705/14

(57) ABSTRACT

The present invention relates to forecasting the performance of advertisements using fuzzy systems. The method according to one embodiment comprises calculating a ranking score for an advertisement, mapping the advertisement to at least one query using a bidded search term and retrieving analytics data for at least one advertisement associated with the mapped query to construct at least one fuzzy set. A fuzzy membership function and at least one rule associated with the fuzzy membership function is identified and a truth level for at least one rank for the advertisement is calculated through the use of the ranking score. At least one average forecasted advertising metric value for the advertisement is calculated, which may be on the basis of one or more of the ranking score, fuzzy set, fuzzy membership function and truth level.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to forecasting the performance of advertisements. More specifically, the present invention provides methods and systems for generating a forecast of the performance of one or more advertisements with respect to one or more advertising metrics using one or more fuzzy systems.

### BACKGROUND OF THE INVENTION

Increasingly, advertisers utilize online or Internet-based advertising in order to promote products or services. With ever-increasing Internet use, it is only natural that greater advertising resources are directed to this growing audience. Furthermore, Internet-based advertising allows great opportunities for advertisers to deliver much more targeted, relevant advertisements than conventional, off-line advertising techniques, such as billboards and the like.

An increasingly important area of advertising includes sponsored listings. Such listing can be presented, for example, in the form of sponsored links appearing among the results of a search conducted using an Internet-based search engine, such as Yahoo!, Ask Jeeves, etc. For instance, auction-based systems exist in which advertisers bid to be included among the sponsored search results for a particular search term or terms, and for the ranking or position of the placement of their advertisements among such results. The performance of a given advertisement, which may be based upon the number of users who view or select the advertisement, is often based upon the ranking or positioning of the advertisement in a ranked list of advertisements. For example, an advertisement displayed first in a ranked list of advertisements is more likely to be seen or selected by a given user than an item ranked second, third, etc.

In auction-based systems, an advertiser may bid upon one or more search terms (hereinafter also referred to as “bidded search terms”) associated with the one or more advertisements the advertiser wishes to display. For example, an advertiser may wish to display one or more advertisements for notebook computers. Accordingly, the advertiser may bid upon terms such as “computer,” “laptop,” “notebook,” etc. Thereafter, if a query comprised of one or more bidded search terms is received by a search provider, such as Yahoo!, the search provider may utilize the bids associated with the one or more terms to determine a ranking for the one or more advertisements displayed in response to the query. For example, the advertiser that provided the greatest bid for a given term associated with a given advertisement may have its advertisement displayed in the most prominent position of a search results page, e.g., ranked first in a ranked list of advertisements, placed at the top of a search results page, etc.

Advertisers may have one or more advertisements directed towards accomplishing an advertising goal, hereinafter referred to as an “advertisement campaign,” such as the marketing or sales of a particular product, service, or content, or a group of products, services or content. An advertiser may wish to ascertain the forecasted performance of one or more advertisements within an advertisement campaign at various bid amounts prior to bidding upon one or more terms associated with the advertisements. For example, an advertiser with a limited budget may want to determine what bid amounts are needed for one or more bidded search terms associated with the plurality of advertisements in a given advertisement campaign in order for Internet users to view the advertisement N times, select the advertisement X times, etc. Similarly, if a given advertisement campaign is directed toward selling a product, an advertiser may seek to use a given budget to place bids upon the bidded search terms associated with the one or more advertisements in the campaign so as to cause a maximum amount of consumers to purchase the product.

Additionally, as previously noted, the ranking of a given advertisement within a ranked list of advertisements is often determinative of the advertisement's performance. Furthermore, the ranking of a given advertisement may depend upon the bid amount an advertiser has provided on one or more bidded search terms associated with the advertisement. An advertiser, may thus wish to obtain information indicating the forecasted rank of a given advertisement within a ranked list of advertisements at a given bid amount for one or more bidded search terms associated with the advertisement.

Systems and methods are therefore needed that provide an advertiser with information indicating the forecasted performance of one or more advertisements associated with one or more bidded search terms at one or more bid amounts for one or more advertising metrics.

### SUMMARY OF THE INVENTION

Embodiments of the invention disclosed herein relates to forecasting the performance of advertisements through the use of fuzzy systems, including fuzzy logic. According to one embodiment, the invention is directed towards a method for forecasting the performance of an advertisement through the utilization of a fuzzy system. The method comprises calculating a ranking score for an advertisement, mapping the advertisement to at least one query using a bidded search term and retrieving analytics data for at least one advertisement associated with the mapped query to construct at least one fuzzy set. A fuzzy membership function and at least one rule associated with the fuzzy membership function is identified and a truth level for at least one rank for the advertisement is calculated through the use of the ranking score. At least one average forecasted advertising metric value for the advertisement is calculated, which may be on the basis of one or more of the ranking score, fuzzy set, fuzzy membership function and truth level.

Identifying the fuzzy membership function may comprise identifying one or more shapes through which the fuzzy function may be expressed. According to embodiments of the invention, the fuzzy function may take the form of one or more shapes including, but not limited to, Gaussian, trapezoidal, triangular, sigmoid and bell shapes. The rule associated with the fuzzy membership function may comprise a prerequisite condition and one or more consequent outcomes associated with the prerequisite condition. The outcome of the rule may be generated on the basis of the analytics data associated with a given fuzzy set.

According to one embodiment, calculating at least one average forecasted advertising metric value comprises using the analytics data associated with the fuzzy set, wherein the analytics data may comprise at least one advertising metric value for one or more advertisements that were displayed at a rank indicated by the fuzzy set. According to embodiments of the invention, the analytics data includes, but is not limited to, a query that resulted in a display of an advertisement, a rank at which a given advertisement was displayed in response to a query, and a ranking score of the advertisement when displayed in response to a query at a given rank. Furthermore, the fuzzy set may comprise a range of ranking scores of one or more advertisements displayed in response to the query at one or more ranks of a ranked list of advertisements and the fuzzy membership function may provide an indication of a degree to which the ranking score results in the advertisement being displayed at a rank indicated by the fuzzy set.

Embodiments of the invention are also directed towards a method for generating a fuzzy system through the use of analytics data to forecast the performance of at least one advertisement. The method of one embodiment comprises identifying at least one query associated with a bidded search term, retrieving analytics data for one or more advertisements displayed in response to the query, the analytics data including at least one rank at which the advertisements were displayed, and identifying a range of ranking scores associated with at least one rank for the query and identifying at least one average advertising metric value obtained at the rank. A fuzzy system is generated with a fuzzy set that corresponds to the rank.

Another embodiment of the invention is directed towards a method for generating a forecast of the performance of an advertisement with respect to a given advertising metric through the use of a fuzzy system. The method according to one embodiment comprises selecting an advertising metric and a rank for an advertisement, generating a truth value for the rank using a ranking score for the advertisement for storage as a first value in a truth value register and calculating an average for the advertising metric at the rank for storage as a second value in an advertising metric register. A forecast is generated on the basis of the quotient of the first value and the second value. Calculating an average for the advertising metric may also comprise calculating a product the average advertising metric and the truth value.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for forecasting the performance of one or more advertisements through the utilization of a fuzzy system according to one embodiment of the present invention;

FIG. 2 is a flow diagram presenting a method for calculating the forecasted performance of one or more advertisements associated with one or more bidded search terms and a maximum bid amount using a fuzzy system according to one embodiment of the present invention;

FIG. 3 is a flow diagram presenting a method for generating one or more rules associated with the one or more fuzzy sets of a fuzzy logic system according to one embodiment of the present invention; and

FIG. 4 is a flow diagram presenting a method for calculating the forecasted performance of a given advertisement with respect to one or more advertising metric values using the one or more fuzzy sets of a fuzzy logic system according to one embodiment of the present invention.

### DETAILED DESCRIPTION OF PREFERRED EMBODIMENTS

In the following description of preferred embodiments, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

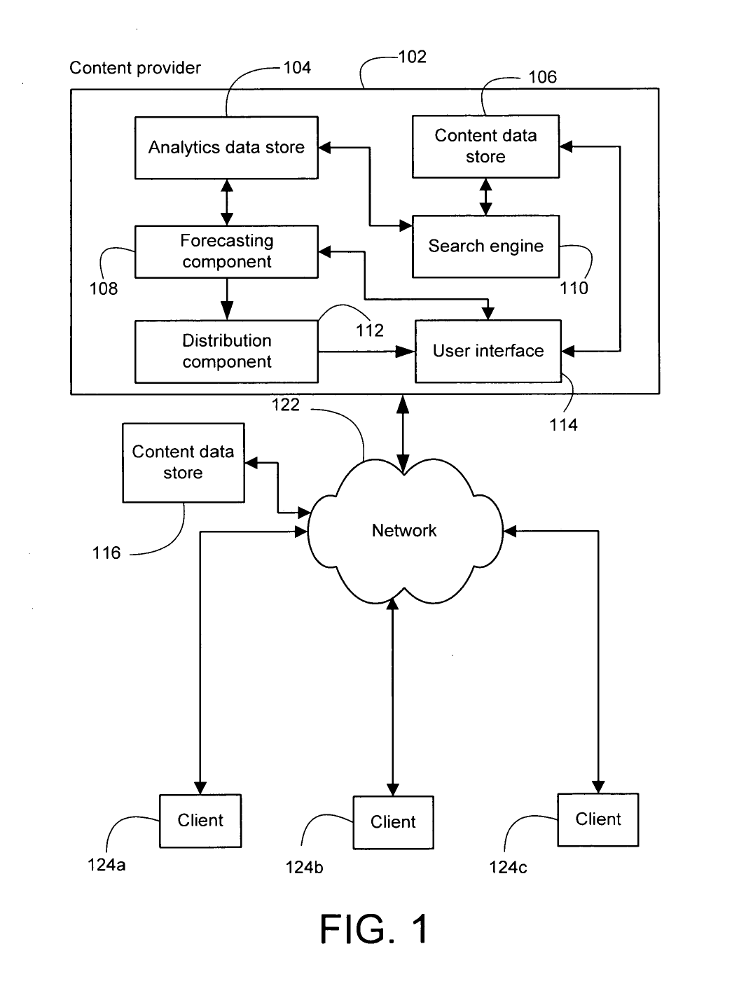

FIG. 1 is a block diagram illustrating a system for forecasting the performance of one or more advertisements associated with one or more bidded search terms and an advertiser specified maximum bid amount through the utilization of a fuzzy system. According to the embodiment of FIG. 1, a content provider 102 maintains one or more advertisement campaigns comprising one or more advertisements in one or more local or more content data stores 106 and 116, respectively. Content data stores 106 and 116 are operative to maintain one or more advertisement campaigns and may comprise one or more accessible memory structures such as a database, CD-ROM, tape, digital storage library, etc. Content data stores 106 and 116 may be implemented as databases or any other type of storage structures capable of providing for the retrieval and storage of a variety of data types.

Advertisers may access the content data store 106 and 116 at the content provider 102 through the use of the content provider user interface 114. The user interface 114 provides an advertiser with the ability to view existing advertisements in the content data store 106 and 116, add new advertisements to the content data store 106 and 116, modify existing advertisements in the content data store 106, remove advertisements from the content data store 106 and 116, create new advertisement campaigns within the content data store 106 and 116, etc. The user interface 114 may be a graphical user interface, a command line interface, or other interface known to those of skill in the art.

The one or more advertisements and advertisement campaigns maintained in the content data stores 106 and 116 are associated with one or more advertiser specified terms. The one or more terms associated with a given advertisement or advertisement campaign may be used to select one or more of the advertisements for distribution in response to a given search request. For example, a given advertisement campaign be directed toward selling wireless routers. Accordingly, the advertiser may specify that advertisements from the advertisement campaign are associated with the terms “wireless,” “wireless router,” “802.11,” etc. When a search query is received from a given user's client device 124a, 124b, and 124c a search engine 110 at the content provider 102 may search content data stores 106 and 116 to determine whether the one or more terms comprising the search query have been specified by an advertiser as associated with one or more advertisement campaigns, e.g., a match between advertisement terms and query terms.

The one or more terms associated with a given advertisement campaign, which may be specified by an advertiser, are further associated with one or more bid amounts. An advertiser's bid amount provides an indication of the dollar amount the advertiser is willing to bid on the one or more terms (“bidded search terms”) associated with the one or more advertisements in a given advertisement campaign. An advertiser may provide a bid for the one or more terms associated with a given advertisement campaign. For example, a given advertiser may specify that the terms “notebook computer” and “laptop computer” are associated with a campaign directed toward advertising notebook computers. The advertiser may further provide a bid amount for the terms “notebook computer” and “laptop computer.” The bid amounts provide an indication of the dollar value the advertiser is willing to spend to display a given advertisement from the advertisement campaign in response to a search query comprised of the one or more advertiser specified bidded search terms.

The search engine 110 may utilize the bid amounts for the one or more bidded search terms associated with the one or more advertisements in a given advertisement campaign to select one or more advertisements for distribution. For example, the search engine 110 may receive a search request from a client device 124a, 124b, and 124c communicatively coupled to the network 122 comprising a search query that includes one or more terms. The search engine 110 may search content data stores 106 and 116 to determine whether one or more advertisers have provided bids for the one or more terms comprising the search query. The search engine 110 may identify the one or more advertisers that provided bids for the one or more terms comprising the search query and select one or more advertisements from the one or more advertisers' campaigns that have provided bids for the one or more terms.

The search engine 110 may identify the expected clicks per thousand impressions (“eCPM”) of the one or more selected advertisements. The eCPM of a given advertisement may be calculated using information including, but not limited to, the historical click through rate of the advertisement and the relevancy of the one or more bidded search terms associated with the advertisement with respect to a given query.

According to one embodiment of the invention, the search engine 110 calculates the product of the bid amount and the eCPM of the one or more selected advertisements yielding a ranking score. The search engine 110 thereafter delivers the one or more selected advertisements and the ranking scores associated with the one or more selected advertisements to a distribution component 112.

The distribution component 112 is operative to rank the one or more advertisements selected according to ranking score and distribute the one or more advertisements to one or more client devices 124a, 124b, and 124c via the network 122. For example, the advertisements selected may be distributed in a search results web page and ranked according to ranking score. A user of a client device 124a, 124b, and 124c may interact with the one or more advertisements displayed, such as by selecting a given advertisement with a selection device such as a mouse or a keyboard.

According to one embodiment of the invention, the distribution component 112 distributes the one or more advertisements selected for distribution with tracking codes. The tracking codes distributed with the one or more advertisements selected for distribution may be used to associate a given advertising metric event with a given advertisement, wherein an advertising metric even may comprise the display of an advertisement, a user's selection of an advertisement, the cost incurred by a given advertiser when the advertiser's advertisement is selected, the query that resulted in the display of an advertisement, etc. The one or more advertising metric events associated with a given advertisement may be maintained in an analytics data store 104.

The analytics data store 104 is an accessible memory structure such as a database, CD-ROM, tape, digital storage library, etc. The analytics data store 104 maintains information regarding user interactions with advertisements and may be implemented as a database or any other type of data storage structure capable of providing for the retrieval and storage of a variety of data types. Advertisement information in the analytics data store 104 may be maintained in groups according to advertiser, product, category, query, or a combination thereof. Advertisement information in the analytics data store 104 may also be maintained according to advertiser specified groups, such as for a given advertisement campaign.

The analytics data store 104 is periodically populated with data indicating user interactions with one or more advertisements, including the one or more queries that resulted in the display of an advertisement. The analytics data store 104 receives analytics data associated with a given advertisement and determines whether an existing record exists for the advertisement data received. If the analytics data store 104 locates a record, the analytics data store 104 updates the existing record to indicate further user interactions with a given advertisement. For example, if the analytics data store 104 receives analytics data indicating that a user of a client device 124a, 124b and 124c selected a given advertisement, the analytics data store 104 determines whether a record exists for the given advertisement. If a record exists, the record is updated to indicate that an additional user selected the given advertisement when displayed in response to a given query. If a record does not exist corresponding to the information received, a new entry is created in the analytics data store 104 for the given advertisement's information.

According to one embodiment of the invention, a record in the analytics data store 104 further stores information indicating the ranking score of an advertisement that resulted in the advertisement's rank within a ranked list of advertisements. For example, a given advertisement may be displayed in a ranked list of advertisements in response to a given query comprised of one or more terms. The analytics data store 104 may maintain information indicating the ranking score, calculated using the bid amount and the eCPM associated with the advertisement, as well as the advertisement's position within the ranked list of advertisements when delivered to a given client device 124a, 124b, and 124c. Additionally, a record in the analytics data store 104 may further indicating the one or more bidded search terms associated with an advertisement that resulted in the display of the advertisement in response to a given query.

The content provider 102 illustrated in FIG. 1 further provides an advertiser with the ability to request forecast information indicating the projected performance of one or more advertisements in a given advertisement campaign associated with one or more advertiser specified bidded search terms and a given maximum bid amount. The user interface 114 allows an advertiser to specify one or more bidded search terms and a maximum bid amount associated with the one or more bidded search terms for a given advertisement. The content provider 102 may utilize the maximum bid amount and the one or more bidded search terms associated with the advertisement to generate a forecast of the projected performance of the advertisement with respect to one or more advertising metrics. For example, a given advertiser may wish to ascertain the performance of a given advertisement directed toward selling laptop computers if the advertiser provided a maximum bid amount of forty cents ($0.40) for the bidded search terms “notebook computer.” The advertiser may thus submit the terms “notebook computer” and the advertiser's maximum bid amount of forty cents to the content provider 102 via the user interface 114 in order to receive information indicating the forecasted performance of the given advertisement.

Information associated with an advertiser's request may be delivered to a forecast component 108 at the content provider 102. The forecast component 108 is operative to calculate a ranking score for the advertiser specified advertisement using the advertiser specified bid amount and corresponding bidded search terms. For example, the forecast component 108 may utilize the historical click through rate of the advertiser specified advertisement, as well as the advertiser specified bid amount for the one or more bidded search terms associated with the advertisement, to calculate a ranking score for the advertisement.

The forecast component 108 is further operative to retrieve analytics data from the analytics data store 104 for the one or more advertisements associated with the one or more advertiser specified bidded search terms. According to one embodiment of the invention, the forecast component 108 maps the one or more advertiser specified bidded search terms associated with the advertiser specified advertisement to one or more queries. As previously described, a given entry in the analytics data store 104 may identify an advertisement, the one or more bidded search terms associated with the advertisement, and the one or more queries that resulted in the display of the advertisement. The forecast component 108 may utilize the information maintained in the analytics data store 104 to map the advertiser specified bidded search terms to one or more queries.

The forecast component 108 thereafter identifies the one or more advertisements associated with the one or more queries to which the advertiser specified advertisement and bidded search terms were mapped. The forecast component 108 retrieves analytics data for the one or more advertisements associated with the one or more queries to which the advertiser specified bidded search terms were mapped, including, but not limited to, the rank at which the one or more advertisements were displayed in response to a given query and the ranking score of the one or more advertisements when displayed in response to a given query at a given rank. The forecasting component 108 further retrieves analytics data indicating the performance of one or more advertisements associated with the advertiser specified bidded search terms at the one or more rankings.

For example, the forecast component 108 may retrieve information from the analytics data store 104 indicating the ranking obtained by one or more advertisements associated with one or more bidded search terms when displayed in response to a given query, as well as the ranking score of the one or more advertisements with respect to the query. Similarly, the forecast component 108 may retrieve analytics data indicating the performance of the one or more advertisements at each respective ranking, wherein the performance of a given advertisement may comprise the number of users that selected the advertisement, the number of times the advertisement was displayed to users, etc.

The forecast component 108 may utilize the analytics data to generate a forecast of the performance of the advertiser specified advertisement associated with the one or more advertiser specified bidded search terms. According to one embodiment of the invention, the forecast component 108 generates a forecast through use of a fuzzy logic system, generated using the analytics data retrieved for the one or more advertisements.

A fuzzy logic system generated by the forecast component comprises one or more fuzzy sets. According to one embodiment of the invention, a fuzzy set comprises the range of the ranking scores of the one or more advertisements displayed in response to a given query to which the advertiser specified advertisement and corresponding bidded search terms were mapped at one or more ranks. For example, an advertiser may wish to ascertain the forecasted performance of an advertisement associated with the bidded search term “computer.” The forecast component 108 may calculate a ranking score for the advertisement and may further identify the one or more queries to which the bidded search term “computer” is associated. The forecast component 108 may thereafter identify the one or more advertisements displayed in response to the one or more queries to which the bidded search term “computer” is associated, and retrieve analytics data associated with the one or more advertisements. As previously described, the analytics data may comprise the ranking scores of the one or more advertisements with respect to the one or more queries, as well as the rank at which the one or more advertisements were displayed in response to the one or more queries.

The queries with which the bidded search “computer” is associated may comprise the query “desktop” and the query “laptop.” The forecast component 108 may identify the one or more advertisements displayed in response to the queries “desktop” and “laptop,” the rank at which the one or more advertisements were displayed in response to the queries, and the ranking score of the one or more advertisements with respect to the queries. The forecast component 108 may thereafter construct one or more fuzzy sets using the identified information. For example, a given fuzzy set may comprise the range of ranking scores of the one or more advertisements displayed at rank one (“1”) of a ranked list of advertisements in response to the query “desktop” or “laptop.” Similarly, a given fuzzy set may comprise the range of ranking scores of the one or more advertisements displayed at rank two (“2”) of a ranked list of advertisements in response to the query “desktop” or laptop.”

The forecast component 108 is further operative to generate one or more membership functions corresponding to the one or more fuzzy sets. According to one embodiment of the invention, a membership function for a given fuzzy set provides an indication of the degree to which a ranking score associated with a given advertisement results in an advertisement being displayed in the position indicated by the given fuzzy set. For example, Table A illustrates one embodiment of a fuzzy logic system with three fuzzy sets, namely, fuzzy set Rank 1, fuzzy set Rank 2, and fuzzy set Rank 3. Each fuzzy set comprises the range of ranking scores of the one or more advertisements that resulted in the one or more advertisements being displayed in position Rank N, wherein N may be the values one (“1”), two (“2”) or three (“3”). The bell shaped curves indicate the membership functions associated with each respective fuzzy set.

In the graph illustrated in Table A, m represents the degree to which a given ranking score x associated with an advertisement results in the advertisement being displayed at position Rank N. X represents the ranking score associated with one or more advertisements that resulted in the one or more advertisements being displayed in position Rank 1, Rank 2, or Rank 3 in response to one or more queries. Rank 1, Rank 2, and Rank 3 represent the ranks of one or more advertisements in a ranked list of advertisements when a given advertisement is associated with a ranking score of x.

While Table A illustrates three fuzzy sets with bell shaped membership functions, those of skill in the art recognize that a fuzzy system generated from analytics data may comprise one or more fuzzy sets with membership functions comprising one or more shapes, including, but not limited to Gaussian, sigmoid, trapezoidal, and triangular shapes.

The forecast component 108 is further operative to generate one or more rules associated with each fuzzy set in the fuzzy system. A rule associated with a given fuzzy set comprises a prerequisite condition identifying the degree to which a given advertisement with a given ranking score is associated with the fuzzy set. A rule may further comprise one or more outcomes, such as the one or more average advertising metric values obtained when an advertisement is associated the fuzzy set. For example, with reference to the fuzzy system illustrated in Table A, Rank 1 may be associated with the following rule:

IF (x is Rank 1) THEN (rank is R₁) AND (imp is A₁)
AND (click is B₁) AND (CPC is C₁).

In the above rule, “x is Rank 1” corresponds to a mathematical evaluation of the degree to which a given ranking score x associated with a given advertisement results in the advertisement being displayed in position Rank 1 (hereinafter referred to as the “truth level” of the rule at x). According to one embodiment of the invention, the truth level of a given rule at a given ranking score x is a value from zero (“0”) to one (“1”). R₁ identifies the rank obtained when a given advertisement is displayed in position Rank 1, e.g., one (“1”). Aₗ identifies the average number of times a given advertisement displayed in Rank 1 may be displayed to users (“impressions”) as indicated by the analytics data associated with the fuzzy system illustrated in Table A. B₁ identifies the average number of users that may select an advertisement displayed in position Rank 1 as indicated by the analytics data associated with the fuzzy system illustrated in Table A. C₁ identifies the average price an advertiser may pay when a user selects an advertisement displayed in position Rank 1 (“cost per click”) as indicated by the analytics data associated with the fuzzy system illustrated in Table A.

The truth level of a given rule at a given ranking score x is used as a weight and applied to the one or more advertising metric value outcomes associated with the rule. For example, with reference to the fuzzy system illustrated in Table A and the abovementioned rule associated with Rank 1, the truth level of “x is Rank 1” may evaluate to 0.6, indicating that the an advertisement associated with one or more bidded search terms with a ranking score of x are in fuzzy set Rank 1 60%. Additionally, the rule associated with fuzzy set Rank 1 may indicate that (rank is 1) AND (imp is 50) AND (click is 90) AND (CPC is $1.10). The truth level of the rule is used as a weight and applied to each respective advertising metric. To obtain the weighted value of each advertising metric, the product of truth level of the rule at ranking score x and each respective advertising metric is calculated. For example, the weighted number of impressions is 0.6×50, yielding 30. Similarly, the weighted cost per click is 0.6×$1.10, yielding $0.66.

The truth levels of the rules associated with the one or more fuzzy sets in a given fuzzy system set are identified and used as weights to calculate the one or more weighted advertising metric values associated with the outcome of each respective rule. The weighted advertising metric values associated with the outcome of each respective rule are combined and used to calculate one or more average weighted advertising metric values.

The average weighted advertising metric values provide a forecast of an advertisement's performance when an advertisement is associated with a ranking score x. The average weighted advertising metric values may be displayed to an advertiser via the user interface. A given advertiser may modify the bid amount or the one or more bidded search terms associated with an advertisement in order to achieve the desired forecasted performance for a given advertisement. Upon identifying a maximum bid and one or more bidded search terms associated with a given advertisement that yields the advertiser's desired forecasted performance for one or more advertisements, the advertiser may submit the bid and the bidded search terms to the content provider via the user interface. The advertiser's maximum bid amount for the one or more bidded search terms may thereafter be used by the content provider when selecting one or more advertisements for distribution in response to one or more requests from client devices 124a, 124b, and 124c.

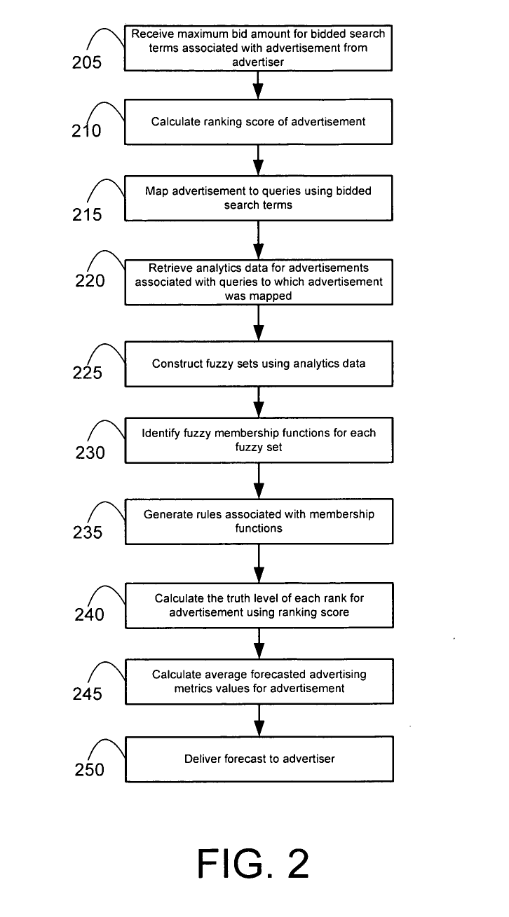

FIG. 2 illustrates one embodiment of a method for generating the forecasted performance of an advertisement associated with one or more bidded search terms and a maximum bid amount. According to the embodiment illustrated in FIG. 2, a maximum bid amount for one or more bidded search terms associated with an advertisement is received from an advertiser, step 205. A ranking score is calculated for the advertisement using the maximum bid amount and one or more advertising metric values associated with the advertisement, step 210. According to one embodiment of the invention, a ranking score comprises the product of the advertiser specified bid amount and the expected clicks per thousand impressions (“eCPM”) associated with the advertisement. The eCPM of an advertisement comprises the expected frequency with which an advertisement is to be selected when displayed one thousand times. The eCPM of an advertisement may be calculated using analytics data associated with the advertisement, such as the historical click through rate of the advertisement.

The one or more bidded search terms associated with the advertisement are mapped to one or more queries, step 215. For example, an advertiser may provide a maximum bid amount for the bidded search term “mortgage.” The bidded search term “mortgage” may be mapped to the queries “home mortgage,” “mortgage rates,” and “refinancing.”

Analytics data corresponding to the one or more advertisements displayed in response to the one or more queries to which the one or more bidded search terms associated with the advertisement are mapped is retrieved, step 220. The analytics data retrieved may comprise information including but not limited to, the query that resulted in the display of an advertisement, the rank at which a given advertisement was displayed in response to a query, and the ranking score of the advertisement when displayed in response to a query at a given rank. For example, with reference to the abovementioned example, analytics data associated with the one or more advertisements displayed in response to the queries “home mortgage,” “mortgage rates,” and “refinancing” may be retrieved. The analytics data may indicate the ranking score of the one or more advertisements displayed at position one, two, three, etc., of a ranked list of advertisements displayed in response to the query “home mortgage,” as well as the ranking scores of the one or more advertisements when displayed at a given rank.

According to one embodiment of the invention, the analytics data may be retrieved for one or more periods of time. For example, analytics data for a period of twenty-four (“24”) hours may be retrieved for the one or more advertisements displayed in response to one or more queries to which the one or more bidded search terms associated with an advertisement are mapped. Similarly, analytics data for a period of one week may be retrieved. According to one embodiment of the invention, an advertiser seeking the forecasted performance of an advertisement may specify the period of time for which analytics data is to be retrieved.

The analytics data associated with the one or more advertisements is used to construct a fuzzy system comprising one or more fuzzy sets, step 225. According to one embodiment of the invention, the one or more fuzzy sets of a fuzzy system comprise the range of ranking scores of the one or more advertisements displayed in response to the one or more queries at one or more ranks of a ranked list of advertisements. For example, a given fuzzy set may comprise the range of ranking scores of the one or more advertisements displayed at rank four (“4”) of a ranked list of advertisements when displayed in response to the query “home mortgage,” “mortgage rates,” or “refinancing.” Similarly, a given fuzzy set may comprise the range of ranking scores of the one or more advertisements displayed at rank one (“1”) of a ranked list of advertisements when displayed in response to the query “home mortgage,” “mortgage rates,” or “refinancing.” A fuzzy set may be generated for the one or more ranks of the one or more queries to which the one or more advertiser bidded search terms are mapped.

One or more fuzzy membership functions are generated corresponding to the one or more fuzzy sets of the fuzzy system, step 230. According to one embodiment of the invention, a fuzzy membership function for a given fuzzy set provides an indication of the degree to which a ranking score associated with an advertisement results in the advertisement being displayed at the rank indicated by the fuzzy set. The membership functions generated for the one or more fuzzy sets of the fuzzy system may comprise one or more shapes, including but not limited to, Gaussian, trapezoidal, triangular, sigmoid, and bell shapes.

A rule is generated for each membership function associated with a given fuzzy set, step 235. A rule associated with a given membership function comprises a prerequisite condition and one or more consequent outcomes associated with the prerequisite condition. According to one embodiment of the invention, the prerequisite condition of a given rule comprises a determination of the degree to which a given ranking score associated with an advertiser specified advertisement results in the advertisement being displayed within a rank indicated by a given fuzzy set.

For example, a given fuzzy system may have a fuzzy set “Rank 1” comprising the range of ranking scores of one or more advertisements displayed in position one of a ranked list of advertisements in response to one or more queries to which one or more advertiser specified bidded search terms are mapped. A triangular membership function may be associated with the fuzzy set Rank 1 indicating the degree to which one or more ranking scores associated with one or more advertisements resulted in the advertisements being displayed at rank one (“1”) of a ranked list of advertisements. The prerequisite condition of a rule associated with the membership function may be used to identify the degree to which a given ranking score associated with a given advertisement results in the advertisement being displayed at a rank indicated by a given fuzzy set, e.g., rank one. For example, the prerequisite condition of the rule associated with the membership function for fuzzy set Rank 1 may be expressed as: “IF (x is Rank 1),” wherein x comprises the ranking score associated with the advertiser specified advertisement.

According to one embodiment of the invention, the prerequisite condition of a rule associated with a given fuzzy set evaluates to a numeric value between zero (“0”) and (“1”), indicating the degree to which a ranking score x associated with a given advertiser specified advertisement results in the advertisement being within the fuzzy set (also referred to as the “truth level” of the rule). For example, the prerequisite condition of a rule associated with a given fuzzy set may evaluate to the truth level 0.25 for a given ranking score of x for a given advertiser specified advertisement. The 0.25 truth level value associated with the ranking score of x indicates that the ranking score x for the advertiser specified advertisement results in the advertisement being within the given fuzzy set 25%. Similarly, the prerequisite condition of a rule associated with a given fuzzy set may evaluate to the truth level 1.0 for a given ranking score of x for a given advertiser specified advertisement. The truth level value 1.0 associated with the ranking score of x indicates that the ranking score of x for the advertiser specified advertisement results in the advertisement being within the given fuzzy set 100%.

The one or more rules associated with the membership functions of the one or more fuzzy sets further comprise one or more consequent outcomes that are generated using the analytics data associated with a given fuzzy set. According to one embodiment of the invention, a consequent outcome associated with a given rule comprises the one or more advertising metrics obtained at a given fuzzy set rank. The average advertising metrics obtained at a given fuzzy set rank may be calculated using the analytics data associated with a given fuzzy set. The analytics data associated with a given fuzzy set may indicate one or more advertising metric values for advertisements that were displayed at the rank indicated by the fuzzy set. For example, the analytics data may indicate that advertisements appearing first in a ranked list of advertisements in response to a search query to which one or more advertiser specified bidded search terms are mapped were displayed an average of 100 times, selected by users an average of 80 times, and cost an advertiser an average of $0.20 when selected by a user.

The truth level of the one or more rules associated with the one or more membership functions for each of the fuzzy sets is calculated, step 240. The truth level of each rule is thereafter used as a weight and applied to the one or more average consequent outcomes associated with a given rule. For example, a given fuzzy set Rank 2 may be associated with the following rule:

IF (x is Rank 2) THEN (rank is 2) AND (imp is 75)
AND (click is 40) AND (CPC is $.20).

The ranking score x associated with the advertiser specified advertisement may evaluate to the truth level value 0.50. The truth level value 0.50 may be applied as a weight to each average advertising metric outcome associated with the rule in order to calculate one or more weighted average advertising metric outcomes. The weighted average advertising metric outcomes associated with each rule are combined according to methods described herein and used to calculate the forecasted advertising metric values obtained by a given advertisement associated with a ranking score of x, step 245. The one or more forecasted advertising metric values may thereafter be delivered to the advertiser with which the request for a forecast originated, step 250.

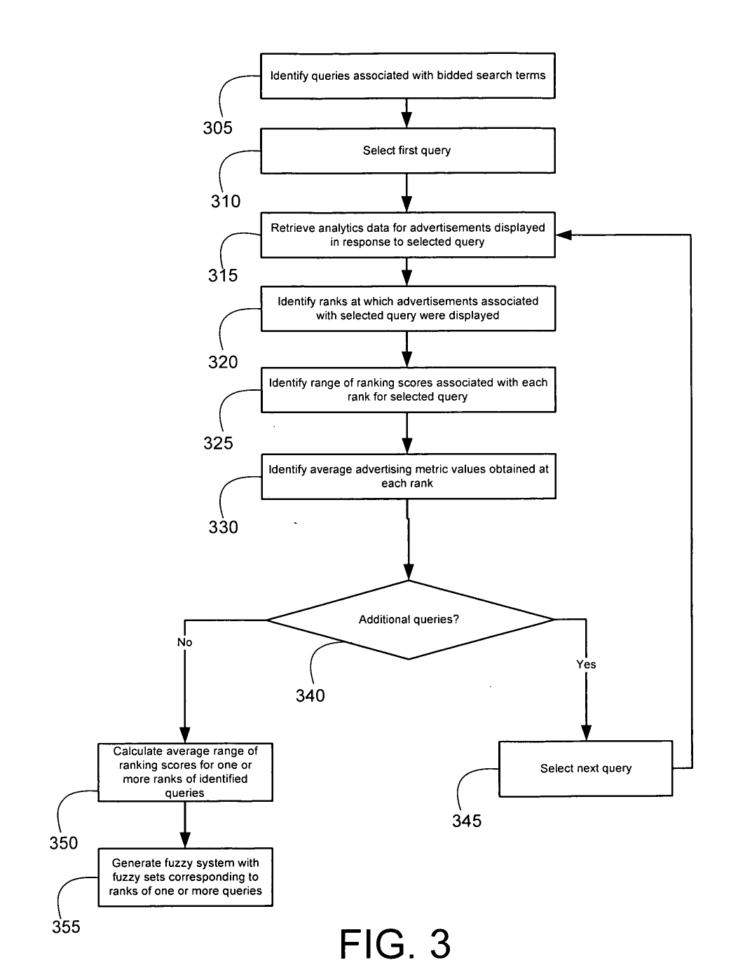

FIG. 3 illustrates one embodiment of a method for generating a fuzzy system comprising one or more fuzzy sets through use of analytics data for forecasting the performance of one or more advertisements. According to the embodiment illustrated in FIG. 3, one or more queries associated with one or more advertiser specified bidded search terms are identified, step 305. A first query is selected from among the one or more identified queries, step 310. Analytics data for the one or more advertisements displayed in response to the selected query is retrieved, step 315. The analytics data associated with the one or more advertisements may comprise data including, but not limited to, data indicating the rank at which the one or more advertisements were displayed, as well as the ranking score of the one or more advertisements displayed at each respective rank.

The one or more ranks at which the one or more advertisements were displayed in response to the selected query are identified, step 320. The range of ranking scores associated with the one or more identified ranks of the one or more advertisements is thereafter identified, step 325. For example, the one or more advertisements displayed in response to a given query may be displayed at rank one (“1”), rank two (“2”), rank three (“3”), and rank four (“4”) of a ranked list of advertisements. The one or more advertisements displayed at rank one (“1”) may have ranking scores ranging from one (“1”) through eight (“8”). Similarly, the one or more advertisements displayed at rank two (“2”) may have ranking scores ranging from six (“6”) through eighteen (“18”). The one or more ranges of ranking scores of the one or more identified ranks for the selected query are identified.

A check is thereafter performed to determine whether one or more additional queries require analysis, step 340. For example, a check may be performed to determine whether the one or more advertiser specified bidded search terms are associated with one or more queries that require analysis. If one or more queries require analysis, a subsequent query is selected, step 345, and the analytics data of the one or more advertisements displayed in response to the selected query is retrieved, step 315.

When the one or more queries with which the one or more advertiser specified bidded search terms are associated have been analyzed, the average range of the ranking scores for the one or more ranks of the one or advertisements displayed in response to the queries is calculated, step 350. For example, a first query Q may be associated with advertisements displayed at ranks one (“1”) and two (“2”). Similarly, a second query Q′ may be associated with advertisements displayed at ranks one (“1”) and two (“2”). The range of ranking scores associated with ranks one and two of query Q may comprise the ranges 1 through 8 and 6 through 18, respectively. The range of ranking scores associated with ranks one and two of query Q′ may comprise the ranges 1 through 10 and 8 through 16, respectively. The average of the range of ranking scores associated with query Q and query Q′ may be calculated in order to generate an average range of ranking scores with respect to the one or more queries with which the one or more advertiser specified bidded search terms are associated. Therefore, the average range of the ranking scores of rank one of query Q and query Q′ comprises the range 1 through 9, whereas the average range of the ranking scores of rank two of query Q and query Q′ comprises the range 7 through 12.

The one or more average ranking score ranges of the one or more rankings

with which the one or more queries are associated may be used to generate a fuzzy system comprising one or more fuzzy sets, step 355. According to one embodiment of the invention, the one or more fuzzy sets of the fuzzy system correspond to the one or more ranking score ranges. Table B illustrates one embodiment of a fuzzy system that may be generated for the one or more ranking score ranges associated with the one or more queries to which one or more advertiser specified bidded search terms may be mapped.

### Table B

In the fuzzy system illustrated in Table B, the range of the ranking scores of the one or more advertisements displayed at Rank 1 is zero (“0”) through ten (“10”). The range of the ranking scores of the one or more advertisements displayed at Rank 2 is eight (“8”) through eighteen (“18”). Additionally, as illustrated in Table B, Rank 3 is associated with only a minimum raking score value, as advertisements with a ranking score exceeding a given ranking score threshold are placed in Rank 3. The generated fuzzy system may be used to provide a forecast of the performance of one or more advertisements according to methods described herein.

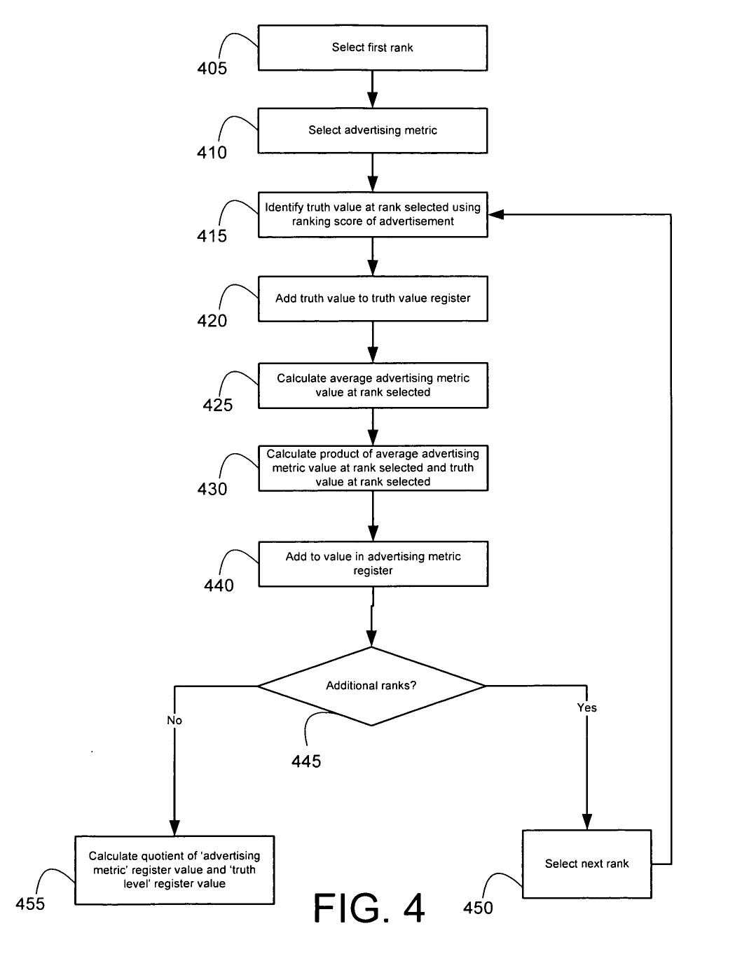

FIG. 4 is a flow diagram illustrating one embodiment of a method for generating a forecast of the performance of an advertisement with respect to a given advertising metric using a fuzzy system. According to the embodiment illustrated in FIG. 4, a first rank corresponding to a given fuzzy set is selected from among the one or more fuzzy sets comprising a fuzzy system, step 405. An advertising metric for which a forecast is to be generated is thereafter selected, step 410. The advertising metric selected may comprise the frequency with which a given advertisement is selected, the cost associated with a user selection of an advertisement, the frequency with which an advertisement is displayed, etc.

The truth value of the advertisement for which a forecast is to be generated is calculated with respect to the selected rank, step 415. For example, as previously described, a fuzzy system comprises one or more fuzzy sets, wherein a given fuzzy set is associated with a rank. The one or more fuzzy sets have corresponding rules, wherein a rule comprises a prerequisite condition and one or more consequent outcomes associated with the rule. According to one embodiment, the prerequisite condition of a rule comprises a mathematical evaluation of the degree to which a given ranking score associated with a given advertisement results in the advertisement being within a given fuzzy set.

The truth value of the advertisement with respect to the selected rank is added to a truth value register, step 420. According to one embodiment of the invention, the truth value register comprises a memory device for storing a given numeric value. The value assigned to the truth value register is used to maintain the truth value of the advertisement for which a forecast is to be generated with respect to the one or more ranks of a fuzzy system.

The average advertising metric value at the rank selected is thereafter calculated for the selected advertising metric, step 425. For example, the average frequency with which one or more users selected one or more advertisements displayed at Rank 1 of a fuzzy system may be calculated. Similarly, the average frequency with which one or more advertisements were displayed at a given rank may be calculated.

The truth value of the advertisement for which a forecast is to be generated is used as a weight and applied to the average advertising metric value of the selected advertising metric. According to the embodiment illustrated in FIG. 4, the product of the average advertising metric value of the advertising metric selected and the truth value of the advertisement for which a forecast is to be generated is calculated, step 430. For example, the truth value of the advertisement with respect to the rank selected may comprise the numerical value “0.6,” indicating the degree to which the advertisement is associated with the selected rank. The average advertising metric value of the advertising metric selected, such as the frequency with which the one or more advertisements displayed at a given rank were selected, may comprise the value “1000.”

The product of the truth value associated with the advertisement with respect to the rank selected and the average advertising metric value of the selected advertising metric yields the numerical value “600.” The calculated product is added to an advertising metric register, step 440. The advertising metric register may comprise a memory device to maintain a numeric value. The value assigned to the advertising metric register is used to maintain the average weighted advertising metric value associated with the advertisement for which a forecast is to be generated.

A check is thereafter performed to determine whether one or more ranks corresponding to one or more fuzzy sets of the fuzzy system require analysis, step 445. If additional ranks require analysis, a next rank corresponding to a given fuzzy of the fuzzy system is selected, step 450. After the one or more ranks of the fuzzy system have been analyzed, the quotient of the advertising metric register and the truth level register are calculated, step 455. The calculated quotient yields the forecasted performance of the advertisement with respect to the selected advertising metric. For example, the calculated quotient may yield the forecasted frequency with which a given advertisement is selected. Alternatively, or in conjunction with the foregoing, the calculated quotient may yield the forecasted frequency with which a given advertisement is displayed, or the cost for one or more user selections of the advertisement when displayed.

The embodiment illustrated in FIG. 4 and discussed above for calculating the forecasted performance of an advertisement with respect to a given advertising metric through use of a fuzzy system may be repeated for the one or more advertising metric values associated with the one or more fuzzy sets of a fuzzy system. For example, the one or more fuzzy sets of a fuzzy system may be associated with one or more advertising metrics, such as the frequency with which the one or more advertisements displayed at a given rank were selected, the cost associated with a user selection of an advertisement at a given rank, and the frequency with which one or more advertisements were displayed at a given rank. The embodiment illustrated in FIG. 3 and discussed above may thus be repeated to generate a forecast of the frequency with which a given advertisement is selected, the forecast of the cost associated with a user selection of the advertisement, or the forecast of the frequency with which the advertisement is displayed. Additionally, those of skill in the art recognize that the embodiment illustrated in FIG. 4 is not limited to the abovementioned advertising metrics and may be used to forecast the performance of an advertisement with respect to a plurality of advertising metrics.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

I claim:

1. A method for forecasting the performance of an advertisement through the utilization of a fuzzy system, the method comprising:
calculating a ranking score for an advertisement;
mapping the advertisement to at least one query using a bidded search term;
retrieving analytics data for at least one advertisement associated with the mapped query to construct at least one fuzzy set;
identifying a fuzzy membership function and at least one rule associated with the fuzzy membership function;
calculating a truth level for at least one rank for the advertisement through the use of the ranking score; and
calculating at least one average forecasted advertising metric value for the advertisement.

2. The method of claim 1 wherein the identifying the fuzzy membership function comprises identifying a shape.

3. The method of claim 2 wherein the shape comprises Gaussian, trapezoidal, triangular, sigmoid and bell shapes.

4. The method of claim 1 wherein the rule comprises a prerequisite condition and one or more consequent outcomes associated with the prerequisite condition.

5. The method of claim 1 comprising generating an outcome of the rule on the basis of the analytics data associated with a given fuzzy set.

6. The method of claim 1 wherein calculating at least one average forecasted advertising metric value comprises using the analytics data associated with the fuzzy set.

7. The method of claim 6 wherein the analytics data comprises at least one advertising metric value for one or more advertisements that were displayed at a rank indicated by the fuzzy set.

8. The method of claim 1 wherein the fuzzy set comprises a range of ranking scores of one or more advertisements displayed in response to the query at one or more ranks of a ranked list of advertisements.

9. The method of claim 1 wherein the fuzzy membership function provides an indication of a degree to which the ranking score results in the advertisement being displayed at a rank indicated by the fuzzy set.

10. the method of claim 1 wherein the analytics data comprises a query that resulted in a display of an advertisement, a rank at which a given advertisement was displayed in response to a query, and a ranking score of the advertisement when displayed in response to a query at a given rank

11. A method for generating a fuzzy system through the use of analytics data to forecast the performance of at least one advertisement, the method comprising:
identifying at least one query associated with a bidded search term;
retrieving analytics data for one or more advertisements displayed in response to the query, the analytics data including at least one rank at which the advertisements were displayed;
identifying a range of ranking scores associated with at least one rank for the query;
identifying at least one average advertising metric value obtained at the rank; and
generating a fuzzy system with a fuzzy set that corresponds to the rank.

12. A method for generating a forecast of the performance of an advertisement with respect to a given advertising metric through the use of a fuzzy system, the method comprising:
selecting an advertising metric and a rank for an advertisement;
generating a truth value for the rank using a ranking score for the advertisement for storage as a first value in a truth value register;
calculating an average for the advertising metric at the rank for storage as a second value in an advertising metric register; and
generating a forecast on the basis of the quotient of the first value and the second value.

13. The method of claim 1 wherein calculating an average for the advertising metric comprises calculating a product the average advertising metric and the truth value.

14. The method of claim 11 comprising selecting another rank.
